(19) United States
(12) Patent Application Publication
(10) Pub. No.: US 2024/0322373 A1
(43) Pub. Date: Sep. 26, 2024

(54) HIGH POWER DENSITY AND LOW-COST LITHIUM-ION BATTERY

(71) Applicant: |-TEN, Dardilly (FR)

(72) Inventor: Fabien GABEN, Dardilly (FR)

(73) Assignee: |-TEN, Dardilly (FR)

(21) Appl. No.: 18/572,853

(22) PCT Filed: Jun. 29, 2022
(86) PCT No.: PCT/IB2022/056051

§ 371 Date: Dec. 21, 2023

(30) Foreign Application Priority Data
Jun. 30, 2021 (FR) 2107016
Jun. 30, 2021 (FR) 2107017
Dec. 23, 2021 (FR) 2114445
Dec. 23, 2021 (FR) 2114448

(51) Int. Cl. H01M 50/46; H01M 4/02; H01M 4/131; H01M 4/1391; H01M 4/485; H01M 4/58; H01M 4/62; H01M 10/0525; H01M 10/0568; H01M 10/0569; H01M 50/11; H01M 50/431; H01M 50/491

(52) U.S. Cl. CPC H01M 50/46; H01M 4/131; H01M 4/1391; H01M 4/485; H01M 4/5825; H01M 4/625; H01M 10/0525; H01M 10/0568; H01M 10/0569; H01M 50/11; H01M 50/431; H01M 50/491; H01M 2004/021; H01M 2300/0028

(57) ABSTRACT

Lithium-ion battery comprising at least one stack which comprises successively: a first electronic current collector, a first porous electrode made of a material selected from the group formed by Nb₂₋ₓM¹ₓO_{5-δ}M³_{δ}, Nb₁₈₋ₓM¹ₓW_{16-y}M²_{y}O_{93-δ}M³_{δ}, Nb₁₆₋ₓM¹ₓW_{5-y}M²_{y}O_{55-δ}M³_{δ}, Nb₂O_{5-δ} with 0≤δ≤2, Nb₁₈W₁₆O_{93-δ} with 0≤δ≤2, Nb₁₆W₅O_{55-δ} with 0≤δ≤2, Li₄Ti₅O₁₂ and Li₄Ti₅₋ₓMₓO₁₂ with M=V, Zr, Hf, Nb, Ta and 0≤x≤0.25, a porous separator made of an electronically insulating inorganic material, a second porous electrode made of a phosphate or a lithium oxide, and a second electronic current collector, knowing that the electrolyte of said battery is a liquid charged with lithium ions confined in said porous layers, each of the three porous layers being free of binder and having a porosity comprised between 20% and 70% by volume.

### CROSS-REFERENCE TO RELATED APPLICATIONS

This application claims priority to PCT Patent Application Serial No. PCT/IB2022/056051, filed on Jun. 29, 2022, which claims priority to the French Patent Application Serial No. FR2107016, filed on Jun. 30, 2021, Serial No. FR2107017, filed on Jun. 30, 2021, Serial No. FR2114448, filed on Dec. 23, 2021, and Serial No. FR2114445, filed on Dec. 23, 2021, all of which are incorporated by reference herein.

### TECHNICAL FIELD

The invention relates to the field of electrochemical systems for the storage of electrical energy, and more particularly that of lithium-ion batteries. The invention relates to a new such battery which has high power density, good stability, and can be used in a very wide temperature range, below −20° C. and above +85° C. It has porous electrodes, with a particular choice of materials. It also allows fast charging. It can be manufactured at low cost, which is partly related to the relatively low cost of raw materials to manufacture the electrodes.

### BACKGROUND

The electronics industry needs secondary batteries, in different forms, for different uses, and with different technical specifications. An urgent need is in particular secondary microbatteries, for example to ensure clock backup functions, power loss protection functions for memories, or energy buffer storage functions for autonomous sensors, smart-cards and RFID tags. Indeed, these electronic devices often include a source of electrical energy production based on different technologies for capturing the surrounding energy. These may be, for example, photovoltaic cells or rectenna for transforming electromagnetic waves into electric current, or else thermopiles.

However, all these energy production sources are not very powerful and their operation depends on their environment. Also, to guarantee the operation of the devices, it is necessary to be able to reliably store this energy and keep it once produced until the electronic device needs it to perform a specific function, which can for example be the emission of a signal or performing a calculation. These specific communication functions or the like, generally require high currents over short times. For example, to carry out a communication on a network, the electronic device may need a few tens of milliamperes for a few hundred milliseconds. The capacity of such microbatteries is typically comprised between approximately 10 μA·h and approximately 0.5 mA·h. In complex circuits, batteries with higher capacities, greater than 1 mA·h, may be preferred, in particular for applications in mobile communication protocols of the 5G type.

Moreover, sensors or other electronic devices are often placed outside, and must be able to operate in a very wide temperature range, typically ranging from −40° C. to +85° C. To date, there is no electronic component capable of performing all these functions. For the batteries and cells to be able to deliver the required currents, their capacity must be relatively high, of the order of several tens or hundreds of mAh. These are essentially button cells or minibatteries. As for supercapacitors, they are very bulky due to their low volumetric energy density, and moreover have a significant self-discharge.

The present invention aims at producing a battery, in particular a microbattery, in the form of an electronic component that can be surface mounted (Surface Mounted Component, SMD), on electronic circuits and assembled by reflow soldering, and which allows to store a large amount of energy, with a small space requirement in order to meet the miniaturisation requirements of the electronics industry. To ensure miniaturisation, this microbattery according to the invention will have to combine the qualities of a battery and a supercapacitor.

Indeed, the current that a battery can deliver is proportional to its capacity. With current technologies, a microbattery, with a capacity of a few tens or even hundreds of μAh, can hardly deliver currents of a few tens of mA. Indeed, rechargeable lithium-ion batteries deliver, for the most powerful of them, a current density of approximately 10 to 50 C. In other words, a battery having a ratio of power P to energy E (P/E ratio) of 10, capable of delivering 10 C, must have a capacity of 5 mAh to deliver a current of 50 mA.

Batteries that can be used to power autonomous sensors must consequently have a capacity of several mAh to be able to power supply the communication transients of autonomous sensors. They are consequently minibatteries, button cells or SMD components, more than microbatteries. The batteries according to the invention allow, by virtue of their high performance, lifespan and autonomy, to ensure the operation of all the connected objects. Minibatteries are particularly capable of meeting the energy needs of any IoT telecommunications protocol. Microbatteries allow to meet the low energy requirements of any communication protocol between machines, known by the acronym M2M (machine to machine), in particular in low-power extended networks such as Bluetooth, LoraWan, zigbee networks which are designed to facilitate long-range communications between sensors and other connected devices, at low data rates.

While lithium-ion batteries meet self-discharge requirements, on the other hand, their operating temperature range remains very limited. Lithium-ion batteries using solvent-based liquid electrolytes and graphite anodes only work up to temperatures of around 60° C. When this temperature is exceeded, they deteriorate rapidly; this degradation can reach the thermal runaway and explosion of the cell.

Another urgent need is expressed by the automotive industry, which needs compact batteries at low cost, with very high power density even at low temperatures, and with excellent cycle life. More particularly, there is a specific need for batteries having these features for use in hybrid vehicles equipped with a combustion engine and an electric motor; this need is reinforced in the context of the technology known as “micro-hybrid” or “mild hybrid”. The cost of batteries, and in particular batteries for electric vehicles, is essentially related to the price of the raw materials constituting the active materials. To achieve the cost objectives of the automotive industry, it is therefore necessary to have inexpensive and abundantly available battery materials. For example, the sale price of batteries for “mild hybrid” type vehicles must not exceed an amount of around $100 per kWh. If this cost problem is solved, the use of these batteries can also be considered in other electric vehicles (electric bicycle, electric scooter, electric kickboard) as well as in other mobile devices (power tools for example), or in stationary electrical energy storage facilities.

For this type of battery, one of the most adapted architectures would be a cell composed of an anode selected from the group formed by:

Nb₂O_{5-δ} with 0≤δ≤2,
Nb₁₈W₁₆O_{93-δ} with 0≤δ≤2,
Nb₂₋ₓM¹ₓO_{5-δ}M³_{δ} wherein
M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M³ is at least one halogen, preferably selected from F, Cl, Br, I or a mixture thereof
and where 0≤x≤1 and 0≤δ≤2,
   Nb₁₈₋ₓM¹ₓW_{16-y}M²_{y}O_{93-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and where 0≤x≤1, 0≤y≤2 and 0≤δ≤2,
   Nb₁₆₋ₓM¹ₓW_{5-y}M²_{y}O_{55-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and where 0≤x≤1, 0≤y≤2 and 0≤δ≤2,
   Nb₁₆W₅O_{55-δ} with 0≤δ≤2,
   Li₄Ti₅O₁₂ or TiNb₂O₇,
   and a cathode LiMn₂O₄ and/or LiFePO₄.

Indeed, these materials contain little or no precious, expensive or rare metal elements, and they are not expensive to synthesise. Moreover, Li₄Ti₅O₁₂ and TiNb₂O₇ operate at high potential, they are compatible with fast recharges and have excellent cycling performance.

### Compounds

Nb₂₋ₓM¹ₓO_{5-δ}M³_{δ} wherein
   M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
   M³ is at least one halogen, preferably selected from F, Cl, Br, I or a mixture thereof
   and where 0≤x≤1 and 0≤δ≤2,
Nb₁₈₋ₓM¹ₓW_{16-y}M²_{y}O_{93-δ}M³_{δ} wherein
   M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
   M¹ and M² can be identical or different from each other,
   M³ is at least one halogen, preferably selected from F, Cl, Br, I or a mixture thereof,
   and where 0≤x≤1, 0≤y≤2 and 0≤δ≤2,
Nb₁₆₋ₓM¹ₓW_{5-y}M²_{y}O_{55-δ}M³_{δ} wherein
   M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
   M¹ and M² can be identical or different from each other,
   M³ is at least one halogen, preferably selected from F, Cl, Br, I or a mixture thereof,
   and where 0≤x≤1, 0≤y≤2 and 0≤δ≤2,
Nb₂O_{5-δ} with 0≤δ≤2,
Nb₁₈W₁₆O_{93-δ} with 0≤δ≤2, and/or
Nb₁₆W₅O_{55-δ} with 0≤δ≤2,
   can be used to form anodes compatible with fast recharges.

However, to be able to use such architectures in the automobile and/or for stationary applications, there are still difficulties to be solved. One of these difficulties is related to the power density: the applications considered require the battery to be able to deliver a high current at very low temperature, of the order of −30° C., whereas lithium-ion batteries according to the prior art do not give satisfaction on this point.

Furthermore, the cycle life of such batteries must be of the order of several hundreds of thousands of charge and discharge cycles. Lithium-ion batteries of the prior art do not allow this. Indeed, as the cycles progress, a loss of electrical contact may occur between the active material particles, which reduces the capacity of the battery.

Regarding the low-cost battery materials mentioned above, LiFePO₄, which can be used as a cathode material, is quite resistive, and it has proven to be very difficult to achieve very high power battery architectures and high energy density with this type of material. Regarding LiMn₂O₄, it is more its stability at high temperature in aprotic solvents that poses a problem. Indeed, above 55° C. the Mn²⁺ ions dissolve in most electrolytes and lead to significant losses in battery performance.

Also, the object of the present invention is to produce a battery that can have a capacity ranging from a few hundredths of a mAh to several tens of Ah, capable of delivering high currents. The battery according to the invention can thus be a single cell, that is to say a battery comprising a single cell, called “battery cell”, or be a battery comprising several cells also called “battery system”. The battery according to the invention can also be:
a battery having a capacity greater than 1 mA h, or
a microbattery, that is to say a battery having a capacity not exceeding 1 mA h, such as a battery in the form of a button cell or an SMD component.

In particular, the present invention allows to produce a microbattery, of very low capacity, meeting the miniaturisation requirements of the electronics industry and capable of delivering high currents. This microbattery must be able to operate at very low temperatures: outdoor electronic applications require an operating temperature down to −40° C., but the electrolytes of conventional lithium-ion batteries freeze at a temperature rather close to −20° C. These outdoor applications also require operation at high temperatures, which can reach or even exceed +85° C., without any risk of ignition.

Moreover, the form factor of this battery must be of the type of a standard SMD component of the electronics industry, in order to be able to be mounted automatically on assembly lines of the pick and place and solder reflow type. In the case of minibatteries, this component can be in the form of a button cell or a through-hole component.

This battery should also have an excellent cycle life, in order to increase the lifespan of abandoned sensors, and limit the maintenance cost associated with premature ageing of the battery.

And finally, this component will have to be equipped with an extremely fast recharging capacity in order to be able to harvest a maximum of energy during very fast recharging transients of the type encountered during a contactless payment, as regards the special case of smart-cards.

The present invention also aims at providing a battery having a capacity greater than 1 mA h, capable of being recharged very quickly from a significant part of its nominal capacity, and which is capable of operating at very low temperature: vehicles must be able to operate outdoors at a temperature down to about −30° C. (knowing that the electrolytes of conventional lithium-ion batteries freeze at a temperature rather close to −20° C. These outdoor applications also require operation at high temperatures, which can reach or even exceed +85° C., without any risk of ignition.

This battery must also have an excellent cycle life, and it must be able to be recharged very quickly from a significant part of its nominal capacity, without this reducing its lifespan, in order to be able to harvest a maximum of energy during an occasional stop at a motorway service area, for example.

### SUMMARY

According to the invention, the problem is solved by a method and a battery which combines a certain number of means.

A first object of the invention is a lithium-ion battery, preferably selected from a microbattery having a capacity not exceeding 1 mA h, and a battery having a capacity greater than 1 mA h, comprising at least one stack which comprises successively: a first electronic current collector, a first porous electrode, a porous separator, a second porous electrode, and a second electronic current collector, knowing that the electrolyte of said battery is a liquid charged with lithium ions confined in said porous layers, said battery being characterised in that:
said first electrode is an anode and comprises a porous layer made of a material PA selected from the group formed by:
   Nb₂₋ₓM¹ₓO_{5-δ}M³_{δ} wherein
M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M³ is at least one halogen, preferably selected from F, Cl, Br, I or a mixture thereof
and where 0≤x≤1 and 0≤δ≤2,
   Nb₁₈₋ₓM¹ₓW_{16-y}M²_{y}O_{93-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and wherein 0≤x≤1, 0≤y≤2 and 0≤δ≤2,
   Nb₁₆₋ₓM¹ₓW_{5-y}M²_{y}O_{55-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and wherein 0≤x≤1, 0≤y≤2 and 0≤δ≤2,
   Nb₂O_{5-δ} with 0≤δ≤2, Nb₁₈W₁₆O_{93-δ} with 0≤δ≤2, Nb₁₆W₅O_{55-δ} with 0≤δ≤2, Li₄Ti₅O₁₂ and Li₄Ti₅₋ₓMₓO₁₂ with M=V, Zr, Hf, Nb, Ta and 0≤x≤0.25 and wherein a part of the oxygen atoms can be substituted by halogen atoms and/or which can be doped by halogen atoms, and said layer being free of binder, having a porosity comprised between 20% and 70% by volume, preferably between 25% and 65%, and even more preferably between 30% and 60%,
said separator comprises a porous inorganic layer made of an electronically insulating inorganic material E, preferably selected from:
   Al₂O₃, SiO₂, ZrO₂, and/or
   a material selected from lithiated phosphates, optionally containing at least one element from: Al, Ca, B, Y, Sc, Ga, Zr; or from lithiated borates which may optionally contain at least one element from: Al, Ca, Y, Sc, Ga, Zr; said material preferably being selected from: lithiated phosphates of the NaSICON type, Li₃PO₄; LiPO₃; Li₃Al_{0.4}Sc_{1.6}(PO₄)₃ called «LASP»; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of these three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li₁₊ₓAlₓTi₂₋ₓ(PO₄)₃ with 0≤x≤1 called «LATP»; or Li₁₊ₓAlₓGe₂₋ₓ(PO₄)₃ with 0≤x≤1 called «LAGP»; or Li₁₊ₓ₊₂Mₓ(Ge_{1-y}Ti_{y})₂₋ₓSi_{z}P_{3-z}O₁₂ with 0≤x≤0.8 and 0≤y≤1.0 and 0≤z≤0.6 and M=Al, Ga or Y or a mixture of two or three of these elements; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1+x+y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements;
      said porous inorganic layer being free of binder, having a porosity comprised between 20% and 70% by volume, preferably between 25% and 65%, and even more preferably between 30% and 60%;
said second electrode is a cathode and comprises a porous layer made of a material PC selected from the group formed by:
   LiFePO₄,
   phosphates of formula LiFeMPO₄ where M is selected from Mn, Ni, Co, V,
   oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5} Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and wherein 0<x<0.1, LiMn₂₋ₓMₓO₄ with M=Er, Dy, Gd, Tb, Yb, Al, Y, Ni, Co, Ti, Sn, As, Mg or a mixture of these compounds and wherein 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
   oxides LiₓM_{y}O₂ where 0.6≤y≤0.85 and 0≤x+y≤2, and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
   Li₁₊ₓNb_{y}Me_{z}AₚO₂ where A and Me are each at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and wherein 0.6<x<1; 0<y<0.5; 0.25≤z<1; with A≠Me and A≠Nb, and 0≤p≤0.2;
   LiₓNb_{y-a}NₐM_{z-b}P_{b}O_{2-c}F_{c} where 1.2<x≤1.75; 0≤y<0.55; 0.1<z<1; 0≤a<0.5; 0≤b<0.1; 0≤c<0.8; and where M, N, and P are each at least one of the elements selected from the group consisting of Ti, Ta, V, Cr, Mn, Fe, Co, Ni, Cu, Zn, Al, Zr, Y, Mo, Ru, Rh, and Sb;
   oxides Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43}Ni_{0.27}O₂; Li_{1.3} Nb_{0.43} Co_{0.27}O₂; Li_{1.4}Nb_{0.2}Mn_{0.53}O₂;
   oxides LiₓNi_{0.2}Mn_{0.6}O_{y} where 0.00≤x≤1.52; 1.07≤y<2.4; Li_{1.2}Ni_{0.2}Mn_{0.6}O₂;
   compounds Li_{1.9}Mn_{0.95}O_{2.05}F_{0.95}, LiVPO₄F, FeF₃, FeF₂, CoF₂, CuF₂, NiF₂, Fe₁₋ₓMₓOF where 0<x<0.2 and M is at least one element selected from the group consisting of Co, Ni, Mn and Cu,
   oxides LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z,
      said porous layer being free of binder, having a porosity comprised between 20% and 70% by volume, preferably between 25% and 65%, and even more preferably between 30% and 60%, said separator comprising a porous inorganic layer deposited on said first and/or second electrode, said porous inorganic layer being free of binder, having a porosity comprised between 20% and 70% by volume, preferably between 25% and 65%, and even more preferably between 30% and 60%.

The coupled use of a porous structure, of an all-ceramic architecture without organic binders, an ionic liquid-based electrolyte (which can only be used due to the all-ceramic structure), corrosion-resistant substrates and, for electrodes exceeding a certain thickness, an electronically conductive coating on the internal surface of the electrodes (and more particularly of the cathode) allows to obtain an extremely reliable cell, which can operate from −40° C. to +125° C., even if the crystallisation temperature of the liquid electrolyte is higher than −40° C. The use of a battery according to the invention at a temperature below −10° C. and/or at a temperature above +80° C. represents another object of the present invention.

The expression “all-ceramic structure”, used in relation to a lithium-ion battery, here means that the solid phase of the battery no longer includes organic residues; any binders, additives or organic solvents used during the method for depositing the layers forming the battery are eliminated by pyrolysis. The liquid electrolyte may include organic material, in particular organic liquids and optionally solvents to dilute them.

This performance of the batteries obtained by the method according to the invention is related to the fact that there is no longer any separator and organic binders. This cell combines this extended operating temperature range with an extraordinary power density in comparison to its power density. It has no safety risk, cell ignition, and can be recharged extremely quickly.

This performance is also related to the choice of materials. The applicant has realised that the cathodes containing manganese oxides do not allow to guarantee long-lasting operation at high temperature because the manganese is likely to dissolve in the usual liquid electrolytes based on aprotic solvents, when the battery operates at a temperature above about 50° C. to 60° C.

According to an essential feature of the invention, the electrode and separator layers are porous. More particularly they comprise an open porosity network. According to a first embodiment, the pores are mesopores and their average diameter is less than 50 nm, preferably comprised between 10 nm and 50 nm, more preferably between 20 nm and 50 nm. These layers can be obtained from a colloidal suspension which comprises aggregates or agglomerates of monodisperse primary nanoparticles with an average primary diameter D₅₀ comprised between 2 nm and 100 nm, preferably between 2 nm and 60 nm, said aggregates or agglomerates having an average diameter D₅₀ comprised between 50 nm and 300 nm, preferably between 100 nm and 200 nm. According to a second embodiment, the pores have an average diameter greater than 50 nm, and more particularly greater than 100 nm. These layers can be obtained from a colloidal suspension which comprises non-agglomerated or non-aggregated primary particles, with an average diameter D₅₀ comprised between 200 nm and 10 μm, preferably between 300 nm and 5 μm; the granulometric distribution of these particles should be quite narrow. The homogeneous size of the particles facilitates their consolidation and leads to a homogeneous pore size.

When the layers of electrodes have a thickness which exceeds about 5 μm to 10 μm, it is particularly advantageous to deposit inside the porous network a thin layer of a material having excellent electronic conductivity, preferably metallic conductivity; this material can be graphitic carbon or an electronically conductive oxide material. When the electrodes have a thickness of only a few micrometres, this coating is not essential; in any case it improves the power performance of the battery.

Another object of the invention is a method for manufacturing a lithium-ion battery, preferably a lithium-ion battery selected from a microbattery having a capacity not exceeding 1 mA h, or a battery having a capacity greater than 1 mA h, said battery comprising at least one stack which comprises successively: a first electronic current collector, a first porous electrode, a porous separator, a second porous electrode, and a second electronic current collector, knowing that the electrolyte of said battery is a liquid charged with lithium ions confined in said porous layers;
said manufacturing method implementing a method for manufacturing an assembly including a first porous electrode and a porous separator,
said first electrode comprising a porous layer deposited on a substrate, said layer being free of binder, having a porosity comprised between 20% and 70% by volume, preferably between 25% and 65%, and even more preferably between 30% and 60%, said separator comprising a porous inorganic layer deposited on said electrode, said porous inorganic layer being free of binder, having a porosity comprised between 20% and 70% by volume, preferably between 25% and 65%, and even more preferably between 30% and 60%,
said manufacturing method being characterised in that:
(a) a first porous electrode layer is deposited on said substrate,
(a1) said first electrode layer being deposited from a first colloidal suspension;
(a2) said layer obtained in step (a1) then being dried and consolidated, by pressing and/or heating, to obtain a first porous electrode; and, optionally,
(a3) said porous layer obtained in step (a2) then receiving, on and inside its pores, an electronically conductive material coating;
being understood that:
   said first porous electrode layer may have been deposited on said first electronic current collector by carrying out the sequence of steps (a1) and (a2), and if necessary step (a3), or
   the layer of a first electrode may have been previously deposited on an intermediate substrate in step (a1), dried and then detached from said intermediate substrate to be subjected to consolidation by pressing and/or heating to obtain a first porous electrode, then placed on said first electronic current collector, and said first porous electrode may have been subjected to step (a3);
(b) a porous inorganic layer of an inorganic material E which must be an electronic insulator is deposited on said first porous electrode deposited or placed in step (a),
(b1) said layer of a porous inorganic layer being deposited from a second colloidal suspension of particles of an inorganic material E;
(b2) said layer obtained in step (b1) then being dried, preferably under a flow of air, and a heat treatment is carried out at a temperature below 600° C., preferably below 500° C., to obtain a porous inorganic layer, in order to obtain said assembly consisting of a porous electrode and a porous separator;
being understood that
   the porous inorganic layer may have been deposited on said first electrode layer, by carrying out the sequence of steps (b1) and (b2), or the inorganic layer may have been previously deposited on an intermediate substrate in step (b1), dried and then detached from said intermediate substrate to be subjected, before or after being deposited on said first electrode layer, to consolidation by pressing and/or heating to obtain a porous inorganic layer;
   said first porous electrode layer and said porous inorganic layer are deposited by a technique selected from the group formed by: electrophoresis, extrusion, a printing method, preferably selected from ink-jet printing and flexographic printing, and a coating method, preferably selected from roll coating, curtain coating, doctor blade coating, extrusion slot die coating, dip-coating;
   said first porous electrode layer and said porous inorganic layer are deposited from colloidal solutions including either
      aggregates or agglomerates of monodisperse primary nanoparticles of at least one active material PA or PC of first electrode, or of at least one inorganic material E, respectively, with an average primary diameter D₅₀ comprised between 2 nm and 100 nm, of preferably between 2 nm and 60 nm, said aggregates or agglomerates having an average diameter D₅₀ comprised between 50 nm and 300 nm, preferably between 100 nm and 200 nm, or
      non-agglomerated or non-aggregated primary particles of at least one active material PA or PC of first electrode, or of at least one inorganic material E, respectively, with a primary diameter D₅₀ comprised between 200 nm and 10 μm, and preferably between 300 nm and 5 μm,
knowing that:
if said first porous electrode is intended to be used in said battery as an anode, said material PA is selected from the group formed by:
   Nb₂₋ₓM¹ₓO_{5-δ}M³_{δ} wherein
      M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
      M³ is at least one halogen, preferably selected from F, Cl, Br, I or a mixture thereof
      and wherein 0≤x≤1 and 0≤x≤2,
   Nb₁₈₋ₓM¹ₓW_{16-y}M²_{y}O_{93-δ}M³_{δ} wherein
      M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
      M¹ and M² can be identical or different from each other,
      M³ is at least one halogen, preferably selected from F, Cl, Br, I or a mixture thereof,
      and wherein 0≤x≤1, 0≤y≤2 and 0≤δ≤2,
   Nb₁₆₋ₓM¹ₓW_{5-y}M²_{y}O_{55-δ}M³_{δ} wherein
      M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
      M¹ and M² can be identical or different from each other,
      M³ is at least one halogen, preferably selected from F, Cl, Br, I or a mixture thereof,
      and wherein 0≤x≤1, 0≤y≤2 and 0≤δ≤2,
   Nb₂O_{5-δ} with 0≤δ≤2, Nb₁₈W₁₆O_{93-δ} with 0≤δ≤2, Nb₁₆W₅O_{55-δ} with 0≤δ≤2, Li₄Ti₅O₁₂ and Li₄Ti₅₋ₓMₓO₁₂ with M=V, Zr, Hf, Nb, Ta and 0≤x≤0.25 and wherein a part of the oxygen atoms can be substituted by halogen atoms and/or which can be doped by halogen atoms;
   and if said first porous electrode is intended to be used in said battery as a cathode, said material PC is selected from the group formed by:
      LiFePO₄,
      phosphates of formula LiFeMPO₄ where M is selected from Mn, Ni, Co, V,
      oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and wherein 0<x<0.1, LiMn₂₋ₓMₓO₄ with M=Er, Dy, Gd, Tb, Yb, Al, Y, Ni, Co, Ti, Sn, As, Mg or a mixture of these compounds and wherein 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤y<0.15, LiNi_{1/x}CO_{1/y}Mn_{1/2}O₂ with x+y+z=10;
      oxides LiₓM_{y}O₂ where 0.6≤y≤0.85 and 0≤x+y≤2, and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
      Li₁₊ₓNb_{y}Me_{z}AₚO₂ where A and Me are each at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and wherein 0.6<x<1; 0<y<0.5; 0.25≤z<1; with A≠Me and A Nb, and 0≤p≤0.2;
      LiₓNb_{y-a}NₐM_{z-b}P_{b}O_{2-c}F_{c} where 1.2<x≤1.75; 0≤y<0.55; 0.1<z<1; 0≤a<0.5; 0≤b<0.1; 0≤x<0.8; and where M, N, and P are each at least one of the elements selected from the group consisting of Ti, Ta, V, Cr, Mn, Fe, Co, Ni, Cu, Zn, Al, Zr, Y, Mo, Ru, Rh, and Sb;
      oxides Li_{1.25} Nb_{0.25}Mn_{0.50}O₂; Li_{1.3} Nb_{0.3}Mn_{0.40}O₂; Li_{1.3} Nb_{0.3} Fe_{0.40}O₂; Li_{1.3}Nb_{0.43} Ni_{0.27}O₂; Li_{1.3} Nb_{0.43}Co_{0.27}O₂; Li_{1.4}Nb_{0.2}Mn_{0.53}O₂;
      oxides LiₓNi_{0.2}Mn_{0.6}O_{y} where 0.00≤x≤1.52; 1.07≤y<2.4; Li_{1.2}Ni_{0.2}Mn_{0.6}O₂;
      compounds Li_{1.9}Mn_{0.95}O_{2.05}F_{0.95}, LiVPO₄F, FeF₃, FeF₂, CoF₂, CuF₂, NiF₂, Fe₁₋ₓMₓOF where 0<x<0.2 and M is at least one element selected from the group consisting of Co, Ni, Mn and Cu,
      oxides LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z.

Advantageously, a second porous electrode layer is deposited on said porous inorganic layer, in a step (c), to obtain a stack comprising a first porous electrode layer, a porous inorganic layer and a second porous electrode layer,
(c1) said second porous electrode layer being deposited from a third colloidal suspension by a technique preferably selected from the group formed by: electrophoresis, a printing method, preferably selected from ink-jet printing and flexographic printing, and a coating method, preferably selected from roll coating, curtain coating, doctor blade coating, extrusion slot die coating, dip-coating, said third colloidal suspension comprising either aggregates or agglomerates of monodisperse primary nanoparticles of at least one active material PA or PC of the second electrode, with an average primary diameter D₅₀ comprised between 2 nm and 100 nm, preferably between 2 nm and 60 nm, said aggregates or agglomerates having an average diameter D₅₀ comprised between 50 nm and 300 nm, preferably between 100 nm and 200 nm, that is to say non-agglomerated or non-aggregated primary particles of at least one active material PA or PC of the second electrode, with a primary diameter D₅₀ comprised between 200 nm and 10 μm, and preferably between 300 nm and 5 μm; and
(c2) said layer obtained in step (c1) having then been consolidated, by pressing and/or heating, to obtain a porous layer; and, optionally,
(c3) said porous layer obtained in step (c2) then receiving, on and inside its pores, an electronically conductive material coating, so as to form said second porous electrode;
it being understood that said second porous electrode layer may have been deposited on said second electronic current collector by carrying out the sequence of steps (c1) and (c2), and where appropriate (c3), or said layer of a second electrode may have been deposited beforehand on an intermediate substrate by carrying out the sequence of steps (c1) and (c2), and if necessary (c3), and then has been detached from said intermediate substrate to be placed on said porous inorganic layer,
and it being understood that in the case where said first electrode layer has been made from a material PA, said second electrode layer is made with a material PC, and that in the case where said first electrode layer was made from a material PC, said second electrode layer is made with a material PA.

Advantageously, a second assembly consisting of a second porous electrode and a second layer of porous separator is deposited on a first assembly including a first porous electrode and a first layer of porous separator, so that said second separator layer is deposited or placed on said first separator layer, to obtain a stack comprising a first porous electrode layer, a porous inorganic layer and a second porous electrode layer.

Advantageously, the pores of said first electrode have an average diameter of less than 50 nm, and/or the pores of said inorganic layer have an average diameter of less than 50 nm, and/or the pores of said second electrode have an average diameter of less than 50 nm.

Advantageously, said stack includes a first porous electrode layer, a porous separator and a second porous electrode layer. Advantageously, this stack is impregnated with an electrolyte, preferably a lithium-ion carrier phase. Advantageously, said electrolyte, preferably said lithium-ion carrier phase, is selected from the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer made ionically conductive by the addition of at least one lithium salt; and
a polymer made ionically conductive by the addition of a liquid electrolyte, either in the polymer phase or in the mesoporous structure,
   said polymer preferably being selected from the group formed by poly(ethylene oxide), poly(propylene oxide), polydimethylsiloxane, polyacrylonitrile, poly(methyl methacrylate), poly(vinyl chloride), poly(vinylidene fluoride), PVDF-hexafluoropropylene.

Advantageously, said material PA is Li₄Ti₅O₁₂ and/or said material PC is LiFePO₄ and/or said material E is Li₃PO₄. Advantageously, said material PA is Li₄Ti₅O₁₂, said material PC is LiMn₂O₄, and said material E is Li₃PO₄. Advantageously, said material PA is Li₄Ti₅O₁₂, said material PC is LiMn_{1.5}Ni_{0.5}O₄ and said material E is Li₃PO₄.

Advantageously, said material PA is Li₄Ti₅O₁₂, said material PC is LiNi_{1/x}Co_{1/y}Mn_{1/2}O₂ with x+y+z=10, and said material E is Li₃PO₄. Advantageously, said porous inorganic layer has a thickness comprised between 3 μm and 20 μm, and preferably between 5 μm and 10 μm. Advantageously, said porous layer of a first electrode has a specific surface comprised between 10 m²/g and 500 m²/g.

### DETAILED DESCRIPTION

### 1. Definitions

In the context of this document, the size of a particle is defined by its largest dimension. “Nanoparticle” means any particle or object of nanometric size having at least one of its dimensions less than or equal to 100 nm.

In the context of this document, the term “electronically conductive oxide” comprises electronically conductive oxides and electronic semiconductor oxides.

In the context of this document, an electronically insulating material or layer, preferably an electronically insulating and ion-conductive layer, is a material or a layer whose electrical resistivity (resistance to the passage of electrons) is greater than 10⁵ Ω·cm. “Ionic liquid” means any liquid salt, capable of transporting ions, differing from all molten salts by a melting temperature below 100° C. Some of these salts remain liquid at room temperature and do not solidify, even at very low temperatures. Such salts are called “Room Temperature Ionic Liquids”, abbreviated RTIL.

“Mesoporous” materials mean any solid which has within its structure pores called “mesopores” having an intermediate size comprised between that of micropores (width less than 2 nm) and that of macropores (width greater than 50 nm), namely a size comprised between 2 nm and 50 nm. This terminology corresponds to that adopted by IUPAC (International Union for Pure and Applied Chemistry), which is a reference for the person skilled in the art. The term “nanopore” is therefore not used here, even if the mesopores as defined above have nanometric dimensions within the meaning of the definition of nanoparticles, knowing that the pores of a size smaller than that of the mesopores are called by the person skilled in the art “micropores”.

A presentation of the concepts of porosity (and of the terminology which has just been exposed above) is given in the article “Texture des matériaux pulvérulents ou poreux” by F. Rouquerol and al., published in the collection “Techniques de l′Ingénieur”, treaty on Analysis and Characterisation, booklet P 1050; this article also describes porosity characterisation techniques, in particular the BET method.

Within the meaning of the present invention, the term “mesoporous layer” means a layer which has mesopores. As will be explained below, in these layers the mesopores contribute significantly to the total pore volume; this state of affairs is translated by the expression “Mesoporous layer of mesoporous porosity greater than X % by volume” used in the description below where X % is preferably greater than 25%, preferentially greater than 30% and even more preferentially between 30 and 50% of the total volume of the layer. The same remark applies to pores which are larger than mesopores according to the IUPAC definition given above.

The term “aggregate” means, according to IUPAC definitions, a weakly bound assembly of primary particles. In this case, these primary particles are nanoparticles with a diameter that can be determined by transmission electron microscopy. An aggregate of aggregated primary nanoparticles can normally be destroyed (that is to say reduced to primary nanoparticles) in suspension in a liquid phase under the effect of ultrasound, according to a technique known to the person skilled in the art.

The term “agglomerate” means, according to IUPAC definitions, a strongly bound assembly of primary particles or aggregates.

Within the meaning of the present invention, the term “electrolyte layer” refers to the layer within an electrochemical device, this device being capable of operating according to its intended purpose. By way of example, in the case where said electrochemical device is a lithium-ion secondary battery, the term “electrolyte layer” designates the “porous inorganic layer” impregnated with a lithium-ion carrier phase. The electrolyte layer is an ion conductor, but it is electronically insulating.

Said porous inorganic layer in an electrochemical device is here also called “separator”, according to the terminology used by the person skilled in the art.

The electrode layers are also porous inorganic layers, but they are referred to herein, as appropriate, as “porous electrode layers” or “first porous electrode layer” and “second porous electrode layer” or “porous anode layer” or “porous cathode layer”.

Unless otherwise stated, particle and agglomerate sizes are expressed in D₅₀.

### 2. General Description of the Layers Forming the Battery Device

According to an essential feature of the method according to the invention, the porous electrode layers and the porous inorganic layer, which are preferably all three mesoporous, can be deposited by different methods, and in particular by electrophoresis, by extrusion, by a coating method such as dip-coating, by roll coating, by curtain coating, by slot die coating or by doctor blade coating, or else by a printing method such as the ink-jet printing method or flexographic printing, from a suspension of aggregates or agglomerates of nanoparticles, preferably from a concentrated suspension containing agglomerates of nanoparticles.

Each electrode must be in surface contact with a current collector, which must have metallic conductivity. Its thickness is advantageously comprised between 5 μm and 15 μm. It is advantageously in the form of a rolled or electrodeposited sheet (possibly deposited on a polymer sheet substrate). During the manufacture of the battery, the current collector can be used as a substrate for the deposition of a first electrode layer; it can also be placed on an electrode layer, before thermocompression of the stack.

The cathode current collector is advantageously selected from the group formed by: molybdenum, tungsten, tantalum, titanium, chromium, nickel, stainless steel, aluminium, electronically conductive carbon (such as graphite, graphene, carbon nanotubes).

The cathode layer should be porous, with a coating of a material with excellent electronic conductivity, preferably metallic conductivity. In a particular embodiment, the cathode layer is mesoporous.

In an advantageous embodiment, which can be combined with all the other embodiments described here, the cathode material is LiFePO₄. This material has several advantages. It is stable at high temperature and does not dissolve in electrolytes (unlike LiMn₂O₄ which loses manganese above 55° C.). However, this material is an electronic insulator; it is advantageous to coat it after deposition of the cathode layer with a thin layer of an electronically conductive material, as will be described below. It operates at low potential and does not risk oxidising its metallic current collector; this allows operation at a higher temperature than other cathode materials. For the same reason, more fluid electrolyte formulations can be used, for example diluted ionic liquids; with cathodes operating at higher potential these liquids can oxidise the cathode current collector, especially at high temperature. The choice of LifePO₄ as the cathode material therefore allows the battery to operate durably at a higher temperature.

The separator must be porous. In a particular embodiment, which can be combined with all the other embodiments described here, the separator layer is mesoporous. Its material must remain stable in contact with the electrodes. In an advantageous embodiment, Li₃PO₄ is used.

The anode layer must be porous. In a particular embodiment, which can be combined with all the other embodiments described here, the anode layer is mesoporous. Its material can be Li₄Ti₅O₁₂. This material has several advantages. Coupled with a cathode LiFePO₄, it allows to design a battery operating at a stable voltage of around 1.5 V, which is compatible with the operating voltage of many electronic circuits. This eliminates the need for an integrated circuit regulator (for example of the LDO type, Low-DropOut regulator) or a DC/DC converter to adapt the battery output voltage to that required by the electronic circuit; this has an advantage for microbatteries.

Moreover, it is a dimensionally stable material, which promotes long-life encapsulation. It also has the advantage of being inexpensive.

Advantageously, the porous anode layer has a coating of a material with excellent electronic conductivity, which is preferably metallic conductivity; this will be described below. A layer of an electronic insulator having an ionic conductivity can be deposited above this coating.

The anode current collector is advantageously selected from the group formed by: molybdenum, tungsten, tantalum, titanium, chromium, copper, stainless steel, aluminium, electronically conductive carbon. It should be noted that copper is not suitable as an anode current collector when the anode layer is deposited by electrophoresis. Likewise, titanium is not suitable as a cathode current collector, when the cathode layer is deposited by electrophoresis. With these substrates, which are less expensive than most of the other substrates mentioned, and which therefore have a real economic advantage, all the other deposition techniques mentioned can be used for the porous electrode layers.

Everything that has just been said in this section 2 applies to porous layers and more specifically to mesoporous layers.

### 3. Layer Deposition and Consolidation Methods

To manufacture a layer of porous electrode or separator, in general, a layer of a suspension or of a paste of particles is deposited on a substrate, by any appropriate technique, and in particular by a method selected from the group formed by: electrophoresis, extrusion, a printing method and preferably ink-jet printing or flexographic printing, a coating method and preferably doctor blade coating, roll coating, curtain coating, dip-coating, or slot die coating. The suspension is typically in the form of an ink, that is to say a fairly fluid liquid, but can also have a pasty consistency. The deposition technique and conduct of the deposition method must be compatible with the viscosity of the suspension or paste, and vice versa.

In general, in the context of the present invention, the first electrode layer may have been deposited on a surface of a substrate capable of acting as an electronic current collector, by carrying out the sequence of steps (a1) and (a2), and if necessary step (a3). Alternatively, the layer of a first electrode may have been previously deposited on an intermediate substrate in step (a1), dried and then detached from said intermediate substrate to be, in step (a2), subjected to consolidation by pressing and/or heating to obtain a first porous electrode plate, then placed on said first electronic current collector. Step (a3), optional, can be performed before or after the deposition of said plate on said first electronic current collector. During drying and consolidation by pressing and/or heating, said first electrode layer undergoes shrinkage which, depending on the thickness of said first electrode layer, would be liable to damage said layer if the latter were fixed on a substrate.

Likewise, the porous inorganic layer of inorganic material E may be deposited on said first electrode layer, by carrying out the sequence of steps (b1) and (b2), or, alternatively, the inorganic layer of inorganic material E may have been deposited beforehand on an intermediate substrate in step (b1), dried and then detached from said intermediate substrate to be subjected, before or after being placed on said first electrode layer, to consolidation by pressing and/or heating to obtain a porous inorganic layer.

These embodiments with intermediate substrate lend themselves particularly well to the manufacture of layers with a thickness greater than 10 μm, and more particularly greater than 20 μm. These thick layers are advantageously used in batteries with a capacity greater than 1 mA h.

In general, in the context of the present invention, suspensions or pastes of particles PA, PC or E with a fairly wide size range can be used.

According to a first embodiment, which is especially suitable for the manufacture of fairly thin layers (typically not exceeding approximately 10 μm), nanoparticles are used. Their primary size can be comprised between about 2 nm and about 150 nm. These nanoparticles form agglomerates whose size is typically comprised between 50 nm and 300 nm. Mesoporous layers are thus obtained. For example, it is possible to use agglomerates with a size comprised between about 100 nm and about 200 nm with nanoparticles with a primary size comprised between about 10 nm and about 60 nm. The granulometry of the primary particles is advantageously monodisperse.

According to a second embodiment, which is especially suitable for the manufacture of fairly thick layers (with a thickness typically greater than about 10 μm, and in particular greater than about 20 μm), larger particles are used, the size of which can reach 1 μm, or even 5 μm or even 10 μm for layers with a thickness greater than a few tens of μm, usable in high-capacity batteries. In the starting suspension, these particles are not normally agglomerated and their particle size is advantageously monodisperse. This embodiment is particularly suitable when the deposition of the suspension or paste is carried out on an intermediate substrate.

These thick layers are particularly suitable for the manufacture of batteries, in particular batteries having a capacity greater than 1 mA h or a capacity not exceeding 1 mA h, such as a battery in the form of a button cell or an SMD component. These thick layers are particularly suitable for single cells, that is to say batteries comprising a single cell, called “battery cell”. In these batteries, said porous layer of a first electrode (whether an anode and/or a cathode) advantageously has a thickness comprised between 4 μm and 400 μm.

After the deposition from the suspension or paste described above, the deposited layer will then be dried. The dried layer is then consolidated to obtain the desired ceramic porous structure. This consolidation will be described below. It comprises a heat treatment and/or a mechanical compression treatment, and possibly a thermomechanical treatment, typically a thermocompression. During this thermal, mechanical or thermomechanical treatment, the electrode layer will be freed of any organic constituent and residue (such as the liquid phase of the suspension of particles, binders and any surfactants): it becomes an inorganic layer (ceramic). The consolidation of a plate is preferably carried out after its separation from its intermediate substrate, because the latter would risk being degraded during this treatment. In one embodiment, the mechanical compression treatment is carried out before the heat treatment.

The consolidation conditions, in particular its temperature, its duration, the pressure applied, depend in particular on the materials, the size of the particles and their state of crystallinity. During this treatment, the particles will change shape and form a continuous porous network by interdiffusion (a phenomenon known as “necking”). Their crystalline state will also change in the sense that the crystallinity improves and the number of defects decreases. Amorphous nanoparticles can crystallise, but this requires a relatively high temperature. For this reason, the choice of the current collector, if present at this stage, must be adapted to this treatment temperature.

In particular, it is noted that when the nanopowders deposited on the substrate by inking are amorphous and/or have many point defects, it is then necessary to carry out a heat treatment which, in addition to the consolidation, will also allow to recrystallise the material in the correct crystalline phase with the correct stoichiometry. For this purpose, it is generally necessary to carry out heat treatments at temperatures located between 50° and 700° C. in air. The current collector will then have to withstand this type of heat treatment, and it is necessary to use materials resistant to these high temperature treatments, such as stainless steel, titanium, molybdenum, tungsten, tantalum, chromium and their alloys.

When the powders and/or agglomerates of nanoparticles are used in crystallised form, which will be the case in particular with nanopowders obtained by hydro-solvothermal synthesis with the right phase and crystalline structure, then it is possible to use heat treatments of consolidation under controlled atmosphere, which will allow the use of less noble substrates such as nickel, copper, aluminium. Since this synthetic route allows to obtain nanoparticles with a very small primary particle size, it will also be possible to reduce the temperatures and/or duration of the consolidation heat treatments to values close to 350° C. or 500° C., which also allows to widen the choice of substrates.

Some syntheses called pseudo-hydrothermal syntheses, however, give amorphous nanoparticles that will need to be recrystallised later.

One of the consequences of the application of consolidation heat treatments in air is that it is no longer possible to have carbon black particles in the electrode to ensure good electronic conduction of the latter. Indeed, the carbon risks being calcined in the form of CO₂ during these heat treatments (especially when the temperatures reach a value of about 500° C.).

The consolidation heat treatment also allows perfect drying of the electrode layers. It is thus possible to use aqueous and/or organic solvents, such as ethanol.

The deposition of the layers, their drying and their consolidation are likely to raise certain problems which will be discussed now. These problems are partly related to the fact that during the consolidation of the layers a shrinkage occurs which generates internal stresses.

According to a first embodiment, the layers of electrodes are each deposited on a substrate capable of acting as an electric current collector. Layers including the suspension of nanoparticles or agglomerates of nanoparticles can be deposited on both sides, by the deposition techniques indicated above.

When it is sought to increase the thickness of the electrodes, it is observed that the shrinkage generated by the consolidation can lead either to the cracking of the layers, or to a shearing stress at the interface between the substrate (which has a fixed dimension) and the ceramic electrode. When this shear stress exceeds a threshold, the layer detaches from its substrate.

To avoid this phenomenon, it is preferred to increase the thickness of the electrodes by a succession of deposition-sintering operation. This first variant of the first embodiment of depositing the layers gives a good result, but is not very productive. Alternatively, in a second variant, layers of greater thickness are deposited on both sides of a perforated substrate. The perforations must have a sufficient diameter so that the two layers of the front and the back are in contact at the perforations. Thus, during consolidation, the nanoparticles and/or agglomerates of electrode material nanoparticles in contact through the perforations in the substrate weld together, forming a point of attachment (welding point between the depositions on the two faces). This limits the loss of adhesion of the layers on the substrate during the consolidation steps.

According to a second embodiment, the electrode layers are not deposited on a substrate capable of acting as an electric current collector, but on an intermediate, temporary substrate. In particular, it is possible to deposit, from suspensions more concentrated in nanoparticles and/or agglomerates of nanoparticles (that is to say less fluid, preferably pasty), fairly thick layers (called “green sheet”). These thick layers are deposited, for example, by a coating method, preferably by doctor blade coating or by extrusion through a slot die. Said intermediate substrate can be a polymer sheet, for example poly(ethylene terephthalate), abbreviated PET, or mylar. When drying, these layers do not crack. For consolidation by heat treatment (and preferably already for their drying) they can be detached from their substrate; electrode plates called “raw” electrode plates are thus obtained after cutting, which after calcination heat treatment and partial sintering will give porous and self-supporting ceramic plates. This embodiment is particularly adapted for the manufacture of fairly thick plates. Not being deposited on a rigid substrate, they can undergo shrinkage during the consolidation treatment without risk of the appearance of cracks.

A stack of three layers is then produced, namely two plates of electrodes of the same polarity separated by a metal sheet capable of acting as an electric current collector. This stack is then assembled by thermomechanical treatment, comprising pressing and heat treatment, preferably simultaneously. Alternatively, to facilitate bonding between the ceramic plates and the metal sheet, the interface can be coated with a layer allowing electronically conductive bonding. This layer can be a sol-gel layer (preferably of the type allowing the chemical composition of the electrodes to be obtained after heat treatment) possibly loaded with particles of an electronically conductive material, which will make a ceramic weld between the porous electrode and the metal sheet. This layer can also consist of a thin layer of non-sintered electrode nanoparticles, or a thin layer of a conductive adhesive (loaded with graphite particles for example), or else a metal layer of a metal with low melting point, or a conductive glue.

Said metal sheet is preferably a rolled sheet, that is to say obtained by rolling. The rolling may optionally be followed by a final anneal, which may be a (total or partial) softening anneal or recrystallisation, according to the terminology of metallurgy. It is also possible to use a sheet deposited electrochemically, for example an electrodeposited copper sheet or an electrodeposited nickel sheet, or else a graphite sheet.

In all cases, a ceramic electrode is obtained, without organic binder, which is porous, located on either side of an electronic current collector, which is typically a collector with metallic conductivity.

In a variant of the method according to the invention, batteries are produced without using current collectors with metallic conductivity. This is possible if the electrode plates are sufficiently electronically conductive to ensure the passage of electrons on the ends of the electrodes. Sufficient electronic conductivity can be observed if the porous surface has been coated with an electronically conductive layer, as will be described below.

It is noted that during the layer deposition steps it is possible to use certain organic binders and/or organic solvents. These organic materials are subsequently eliminated by heat treatment in an oxidising atmosphere; this treatment is pyrolysis.

Everything that has just been said in this section 3 applies to porous layers and more specifically to mesoporous layers.

### 4. Deposition of a Thin Electronic Conductor Layer in the Porous Network of Electrodes

This step is optional. The thin electronic conductor layer decreases the series resistance of the electrode layer. For electrodes with a thickness that does not exceed a few micrometres (typically 2 μm to 5 μm), the deposition of this thin electronic conductor layer is not essential. On the other hand, to improve the power of the battery, and/or for increasing the thickness of the electrodes (for example beyond 10 μm) the deposition of this electronically conductive thin layer represents a preferred embodiment of the invention. By way of example, this electronically conductive thin layer is very advantageous in the case of thick monocells mentioned in section 3 above, since their series resistance would otherwise be too large.

According to this embodiment of the invention, an electronically conductive material coating is deposited on and inside the pores of the porous electrode layer. Advantageously, at least one of the two porous layers, preferably the porous layer made of a material PC, includes, on and inside its pores, an electronically conductive material coating. This electronically conductive material can be deposited on the porous layer made of a material PC as indicated below (porous cathode layer) and/or on the porous layer made of a material PA as indicated below (porous anode layer). This electronically conductive material is advantageously deposited on the porous layer made of a material PC as indicated below (porous cathode layer). The electronically conductive material coating on and inside the pores of the porous cathode layer (that is to say cathode) allows to block parasitic reactions at the surface of the cathode which degrade the lifespan. The presence of such a coating on a manganese-based cathode allows to avoid the dissolution of Mn²⁺ in the electrolyte.

This electronically conductive material can be deposited by the atomic layer deposition technique (abbreviated ALD) or from a liquid precursor. Said electronically conductive material can be carbon or an electronically conductive oxide material. Its thickness is typically of the order of 0.5 nm to 20 nm, and preferably comprised between 0.5 nm and 10 nm. This coating substantially covers the entire surface of the pores.

To deposit a carbon layer from a liquid precursor, the mesoporous layer can be immersed in a solution rich in a carbon precursor (for example a solution of a carbohydrate, such as sucrose). The layer is then dried and subjected to a heat treatment, preferably under an inert atmosphere, such as under nitrogen, at a temperature sufficient to pyrolyze the carbon precursor. Thus, a very thin coating of carbon is formed on the entire internal surface of the porous layer, perfectly distributed. This coating gives the electrode good electronic conduction, regardless of its thickness. It is noted that this treatment is possible after sintering because the electrode is entirely solid, without organic residues, and resists the thermal cycles imposed by the various heat treatments.

This electronically conductive layer reduces the series resistance of the battery, which is very advantageous for relatively thick electrodes, which would otherwise show a too high resistance. This also increases the possibility of delivering high pulse power with such a battery.

This electronically conductive layer can also protect the surface of the anode at high temperature against possible parasitic reactions of the anode with the electrolyte.

The layer of an electronically conductive material can be formed, very advantageously, by immersion in a liquid phase including a precursor of said electronically conductive material followed by the transformation of said precursor of an electronically conductive material into an electronically conductive material by heat treatment. This method is simple, fast, easy to implement and is less expensive than the atomic layer deposition technique ALD.

To deposit a layer of an electronically conductive oxide material from a liquid precursor, the porous layer (that is to say porous network of the electrode such as a cathode or an anode) can be immersed in a solution rich in a precursor of said electronically conductive oxide material. Then the layer is dried and subjected to a heat treatment, such as calcination, preferably carried out in air or under an oxidising atmosphere in order to transform said precursor of the electronically conductive oxide material into electronically conductive oxide material.

Advantageously, said precursor of the electronically conductive oxide material can be selected from organic salts containing one or more metal elements capable, after heat treatment such as calcination, preferably carried out in air or under an oxidising atmosphere, of forming an electronically conductive oxide. These metal elements, preferably these metallic cations, can advantageously be selected from tin, zinc, indium, gallium, or a mixture of two or three or four of these elements. The organic salts are preferably selected from an alkoxide of at least one metal element capable, after heat treatment such as calcination, preferably carried out in air or under an oxidising atmosphere, of forming an electronically conductive oxide, an oxalate of at least one metal element capable, after heat treatment such as calcination, preferably carried out in air or under an oxidising atmosphere, of forming an electronically conductive oxide and an acetate of at least one metal element capable, after heat treatment such as calcination, preferably carried out in air or under an oxidising atmosphere, to form an electronically conductive oxide.

Advantageously, said electronically conductive material may be an electronically conductive oxide material, preferably selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of four of these oxides,
doped oxides based on zinc oxide, the doping being preferably with gallium (Ga) and/or with aluminium (Al) and/or with boron (B) and/or with beryllium (Be), and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped oxides based on indium oxide, the doping being preferably with tin (Sn), and/or with gallium (Ga) and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped tin oxides, the doping being preferably with arsenic (As) and/or with fluorine (F) and/or with nitrogen (N) and/or with niobium (Nb) and/or with phosphorus (P) and/or with antimony (Sb) and/or with aluminium (Al) and/or with titanium (Ti), and/or with gallium (Ga) and/or with chromium (Cr) and/or with cerium (Ce) and/or with indium (In) and/or with cobalt (Co) and/or with nickel (Ni) and/or with copper (Cu) and/or with manganese (Mn) and/or with germanium (Ge).

To obtain a layer of an electronically conductive material, preferably an electronically conductive oxide material, from an alkoxide, an oxalate or an acetate, the porous layer (that is to say porous network of the electrode such as a cathode or an anode) can be immersed in a solution rich in the precursor of the desired electronically conductive material. Then the electrode is dried and subjected to a heat treatment at a temperature sufficient to transform (calcine) the precursor of the electronically conductive material of interest. Thus, an electronically conductive material coating is formed, preferably an electronically conductive oxide material coating, more preferably SnO₂, ZnO, In₂O₃, Ga₂O₃, or indium-tin oxide, over the entire internal surface of the electrode, which is perfectly distributed.

The presence of an electronically conductive coating in the form of an oxide instead of a carbon coating on and inside the pores of the porous layer gives the electrode better electrochemical performance at high temperature, and allows to significantly increase the stability of the electrode. The fact of using an electronically conductive coating in the form of an oxide instead of a carbon coating confers, among others, better electronic conduction at the final electrode. Indeed, the presence of this layer of electronically conductive oxide on and inside the pores of the porous layer or plate, in particular due to the fact that the electronically conductive coating is in the form of oxide, allows to improve the final properties of the electrode, in particular to improve the voltage resistance of the electrode, its temperature resistance, to improve the electrochemical stability of the electrode, in particular when it is in contact with a liquid electrolyte, to reduce the electrode bias resistance, even when the electrode is thick. It is particularly advantageous to use an electronically conductive coating in the form of an oxide, in particular of the In₂O₃, SnO₂, ZnO, Ga₂O₃ type or a mixture of one or more of these oxides, on and inside the pores of the porous layer of an electrode active material, when the electrode is thick, and/or the active materials of the porous layer are too resistive. The presence of a ZnO coating on and inside the pores of the porous layer gives the electrode excellent electrochemical performance at high temperature, and significantly increases the stability and lifetime of the electrode.

The electrode according to the invention is porous, preferably mesoporous, and its specific surface is large. The increase in the specific surface of the electrode multiplies the exchange surfaces, and consequently, the power of the battery, but it also accelerates the parasitic reactions. The presence of these electronically conductive coatings in the form of oxide on and inside the pores of the porous layer will allow to block these parasitic reactions. Moreover, due to the very large specific surface, the effect of these electronically conductive coatings in oxide form on the electronic conductivity of the electrode will be much more pronounced than in the case of a conventional electrode, where the specific surface is less, even if the conductive coatings deposited have a small thickness. These electronically conductive coatings, deposited on and inside the pores of the porous layer, give the electrode excellent electronic conductivity.

It is essentially the synergistic combination of a porous layer or plate made from an active electrode material, and an electronically conductive coating in the form of an oxide placed on and inside the pores of said porous layer or plate which allows to improve the final properties of the electrode, in particular to obtain thick electrodes without increasing the internal resistance of the electrode.

Moreover, the electronically conductive coating in the form of oxide on and inside the pores of a porous layer is easier and less expensive to achieve than a carbon coating. Indeed, in the case of coatings made of electronically conductive material in oxide form, the transformation of the precursor of the electronically conductive material into an electronically conductive coating does not need to be carried out under an inert atmosphere, unlike the carbon coating.

Optionally, it is possible to deposit above this electronically conductive layer, that is to say above this layer of said electronically conductive material coating, a layer which is electronically insulating and which has good ionic conductivity; its thickness is typically in the range of 1 nm to 20 nm. This electronically insulating layer, which has an ionic conductivity, allows to improve the resistance of the electrode (anode and/or cathode) to temperature, and ultimately to increase the temperature resistance of the battery.

Said ionic conductive and electronic insulating layer can be of inorganic or organic nature. More particularly, among the inorganic layers it is possible to use for example an oxide, a phosphate or a borate conducting lithium ions, and among the organic layers it is possible to use polymers (for example PEO optionally containing lithium salts, or a sulfonated tetrafluoroethylene copolymer such as Nafion™, CAS N^{o} 31175-20-9).

This layer, or set of layers, has different functions. A first function is to improve the electrical conductivity of the electrode, knowing that the intrinsic conductivity of LiMn₂O₄ or LiFePO₄ electrodes is not very high. A second function is to limit the dissolution of ions from the electrode and their migration towards the electrolyte, knowing that in LiMn₂O₄ electrodes manganese risks dissolving in certain liquid electrolytes, in particular at high temperature. And finally, due to the method used in the present invention, the deposition of said ionic conductive and electronic insulating layer extends to the metal surface of the collector and protects the latter against corrosion. If only the electronically conductive layer is present, it will ensure the function of improving the electrical conductivity of the electrode and that of limiting the dissolution of the electrode. If the electronically conductive layer is covered with an ionic conductive layer, it is the latter which will mainly perform the protective functions, as described above.

To summarise, with these coatings deposited on and inside the pores of the porous electrode layer, two effects are sought: the increase in electronic conductivity and protection against dissolution in the electrolyte at high temperature. Either these two effects are obtained with a single coating, namely an electronically conductive layer, or a single coating is not sufficient to obtain both effects in which case two layers can be deposited, for example, a first layer to obtain electronic conduction and a second ion conductor and electronic insulator layer; to achieve high temperature protection.

### 5. Impregnation with a Liquid Electrolyte

This impregnation is explained here for the mesoporous layers. Unless otherwise stated, it also applies more generally to porous layers having pores larger than mesoporous.

In order for said porous separator layer to be able to fulfil its electrolyte function, it must be impregnated with a liquid carrying mobile cations; in the case of a lithium-ion battery, this cation is a lithium cation. In general, this lithium-ion carrier phase is in the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer made ionically conductive by the addition of at least one lithium salt; and
a polymer made ionically conductive by the addition of a liquid electrolyte, either in the polymer phase or in the mesoporous structure,
   said polymer preferably being selected from the group formed by poly(ethylene oxide), poly(propylene oxide), polydimethylsiloxane, polyacrylonitrile, poly(methyl methacrylate), poly(vinyl chloride), poly(vinylidene fluoride), PVDF-hexafluoropropylene.

The impregnation can be done at different steps of the method. It can be done in particular on stacked and thermocompressed cells, that is to say once the battery is finished. It can also be done after encapsulation, from the cutting edges. More particularly, the stack including a first porous electrode layer, a porous separator and a second porous electrode layer is impregnated with said liquid electrolyte. The liquid electrolyte instantly enters by capillarity into the porosities of the mesoporous layers and remains confined in the mesoporous structure. Said ionic liquids can be molten salts at room temperature (these products are known under the designation RTIL, Room Temperature Ionic Liquid), or ionic liquids which are solid at room temperature. Ionic liquids that are solid at room temperature must be heated to liquefy them to impregnate the mesoporous structure; they solidify after their penetration into the mesoporous structure. In the context of the present invention, RTILs are preferred.

Said ion-conductive polymer can be melted to be mixed with the lithium salt and this molten phase can then be impregnated into the mesoporosity. Likewise, said polymer can be a liquid at room temperature, or else a solid, which is then heated to make it liquid in order to impregnate it into the mesoporous structure.

The lithium-ion carrier phase can be an electrolytic solution comprising an ionic liquid. The ionic liquid consists of a cation associated with an anion; this anion and this cation are chosen so that the ionic liquid is in the liquid state in the operating temperature range of the accumulator. The ionic liquid has the advantage of having high thermal stability, reduced flammability, non-volatile, low toxicity and good wettability of ceramics, which are materials that can be used as electrode materials.

The cations of this ionic liquid are preferentially selected from the group formed by the following cationic compounds and families of cationic compounds: imidazolium (such as the 1-pentyl-3-methylimidazolium cation, abbreviated PMIM), ammonium, pyrrolidinum, and/or the anions of this ionic liquid are preferentially selected from the group formed by the following anionic compounds and families of anionic compounds: bis(trifluoromethanesulfonyl)imide, bis(trifluorosulfonyl)imide, trifluoromethylsulfonate, tetra-fluoroborate, hexafluorophosphate, 4,5-dicyano-2-(trifluoromethyl)imidazolium (abbreviated TDI), bis(oxlate)borate (abbreviated BOB), oxalyldifluoroborate (abbreviated DFOB), bis(mandelato)borate (abbreviated BMB), bis(perfluoropinacolato) borate (abbreviated BPFPB).

In the context of the present invention, the ionic liquids confer better high temperature resistance on the battery. Their use is also recommended when using a cathode based on LiMn₂O₄ because under these conditions, the dissolution of manganese, which is undesirable, is greatly slowed down. This cathode material operates at a high potential of the order of 4.2 V, which poses the problem of corrosion of the metal surface of the collector; the kinetics of this oxidative corrosion depends on the potential, the temperature and the nature of the electrolyte. This corrosion can be slowed down when using an ionic liquid without solvent, and when the ionic liquid comprises molecules that do not contain sulphur; for this reason sulphur-free lithium salts are preferred in ionic liquids, such as lithium bis(oxalato)borate (commonly abbreviated “LiBOB”, CAS N^{o}: 244761-29-3), lithium difluoro(oxalato)borate (commonly abbreviated “LiDFOB”, CAS N^{o}: 409071-16-5), lithium 4,5-dicyano-2-(trifluoromethyl) imidazole (commonly abbreviated “LiTDI”, CAS N^{o}: 761441-54-7). This corrosion obviously also depends on the nature of said metal surface, and as such molybdenum, tungsten and titanium are particularly resistant.

On the other hand, with a LiFePO₄ cathode, solvents can be used in the formulation of the liquid phase of the electrolyte because this cathode material has an operating potential around 3.0 V, and at this value no corrosion is observed on the metal collectors.

By way of example, some electrolytes that can be used in the context of the present invention are: an electrolyte comprising N-butyl-N-methyl-pyrrolidinium 4,5-dicyano-2-(trifluoromethyl) imidazole (Pyr₁₄TDI), and an electrolyte comprising 1-Methyl-3-propylimidazolium 4,5-dicyano-2-(trifluoro-methyl)imidazolide (PMIM-TDI) and lithium 4,5-dicyano-2-(trifluoro-methyl) imidazolide (LiTDI). PYR₁₄TFSI and LiTFSI can also be used. Advantageously, the ionic liquid can be a cation of the 1-Ethyl-3-methylimidazolium type (also called EMI⁺ or EMIM⁺) and/or n-propyl-n-methylpyrrolidinium (also called PYR₁₃⁺) and/or n-butyl-n-methylpyrrolidinium (also called PYR₁₄⁺), associated with anions of the bis(trifluoromethanesulfonyl)imide (TFSI⁻) and/or bis(fluorosulfonyl)imide (FSI⁻) type. In an advantageous embodiment, the liquid electrolyte contains at least 50% by mass of ionic liquid, which is preferably Pyr₁₄TFSI.

Among the other cations which can be used in these ionic liquids, mention is also made of PMIM⁺. Among the other anions which can be used in these ionic liquids, mention is also made of BF₄⁻, PF₆⁻, BOB⁻, DFOB⁻, BMB⁻, BPFPB⁻. To form an electrolyte, a lithium salt such as LiTFSI can be dissolved in the ionic liquid which serves as the solvent or in a solvent such as γ-butyrolactone. γ-butyrolactone prevents the crystallisation of ionic liquids inducing a greater temperature operating range of the latter, in particular at low temperature.

Advantageously, when the porous cathode comprises a lithium phosphate, the lithium-ion carrier phase comprises a solid electrolyte such as LiBH₄ or a mixture of LiBH₄ with one or more compounds selected from LiCl, LiI and LiBr. LiBH₄ is a good conductor of lithium and has a low melting point facilitating its impregnation in porous electrodes, in particular by dipping. Due to its extremely reducing properties, LiBH₄ is little used as an electrolyte. The use of a protective film on the surface of the porous lithium phosphate electrode prevents the reduction of cathode materials by LiBH₄ and avoids its degradation.

In general, it is advantageous for the lithium-ion carrier phase to comprise between 10% and 40% by weight of a solvent, preferably between 30 and 40% by weight of a solvent, and even more preferably between 30 and 40% by mass of γ-butyrolactone, glyme or polycarbonate. In an advantageous embodiment, the lithium-ion carrier phase comprises more than 50% by mass of at least one ionic liquid and less than 50% of solvent, which limits the risks of safety and inflammation in the event of a malfunction of the batteries comprising such a carrier phase of lithium ions.

In advantageous embodiments, the lithium-ion carrier phase comprises:
a lithium salt or a mixture of lithium salts selected from the group formed: LiTFSI, LiFSI, LiBOB, LIDFOB, LIBMB, LiBPFPB and LiTDI; the lithium salt concentration is preferably comprised between 0.5 mol/L and 4 mol/L; the applicant has found that the use of an electrolyte with a high concentration of lithium salts promotes very fast charging performance;
a solvent or a mixture of solvents with a mass content of less than 40% and preferably less than or equal to 20%; this solvent can be for example γ-butyrolactone, polycarbonate, glymes;
optionally additives to stabilise the interfaces and limit parasitic reactions, such as 4,5-dicyano-2-(trifluoromethyl)imidazole salts, known by the acronym TDI, or vinyl carbonate, known by the acronym VC.

In another embodiment, the lithium-ion carrier phase comprises:
between 30 and 40% by mass of a solvent, preferably between 30 and 40% by mass of γ-butyrolactone, or PC or glyme, and
more than 50% by mass of at least one ionic liquid, preferably more than 50% by mass of PYR₁₄TFSI.
   By way of example, the lithium-ion carrier phase can be an electrolytic solution comprising PYR₁₄TFSI, LiTFSI and γ-butyrolactone, preferably an electrolytic solution comprising approximately 90% by mass of PYR₁₄TFSI, 0.7 M of LiTFSI, 2% LiTDI and 10% by mass of γ-butyrolactone.

### 6. Description of Some Particularly Advantageous Batteries

Some particularly advantageous batteries that can be manufactured with the method according to the invention are described here.

A first advantageous embodiment is a microbattery with:
a LiFePO₄ cathode with a thickness comprised between approximately 1 μm and approximately 10 μm, with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or more of these oxides), a few nanometres thick over the entire mesoporous surface;
   a Li₃PO₄ separator with a thickness comprised between approximately 1 μm and approximately 10 μm with a mesoporous porosity of approximately 35% and approximately 60%;
a Li₄Ti₅O₁₂ anode with a thickness comprised between approximately 1 μm and approximately 10 μm with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or more of these oxides), a few nanometres thick over the entire mesoporous surface.

The layer of an electronically conductive material coating is not necessary as long as the layers are not too thick, that is to say as long as at least the thickness of the electrodes remains less than approximately 5 μm or 6 μm.

The electrolyte can be an ionic liquid, for example EMIM-TFSI+LiFSI or Pyr₁₄TFSI+LiTFSI. Such a battery operates in a particularly wide temperature range, between about −40° C. and about +125° C. It can be recharged very quickly, to about 80% of its full capacity in less than 3 minutes. It does not have a risk of thermal runaway.

A second advantageous embodiment is a microbattery formed by:
a LiMn₂O₄ cathode with a thickness comprised between approximately 2 μm and approximately 10 μm, with a mesoporous porosity of approximately 35% to approximately 60% including, preferably, on and inside its pores a layer of an electronically conductive material coating (layer of carbon or layer of an electronically conductive oxide material coating, preferably selected from In₂O₃, SnO₂, ZnO, Ga₂O₃ and a mixture of one or more of these oxides), of a thickness of approximately 1 nanometre over the entire mesoporous surface then covered by approximately 2 nanometres with a Nafion-type polymer film;
   a Li₃PO₄ separator with a thickness comprised between approximately 1 μm and approximately 10 μm with a mesoporous porosity of approximately 35% and approximately 60%;
a Li₄Ti₅O₁₂ anode with a thickness comprised between about 2 μm and about 10 μm with a mesoporous porosity of about 35% to about 60% including, preferably, on and inside its pores a layer of an electronically conductive material coating (layer of carbon or layer of an electronically conductive oxide material coating, preferably selected from In₂O₃, SnO₂, ZnO, Ga₂O₃ and a mixture of one or more of these oxides), of a thickness of about 1 to 2 nanometres over the entire mesoporous surface.

The electrolyte can be an ionic liquid, for example EMIM-TFSI+LiFSI or Pr14TSFI+LiTDI or Pyr₁₄TFSI+LiTFSI. The latter being less fluid (and often requiring dilution in a suitable solvent) and stable up to around 5.0 V, the former being stable up to around 4.7 V, the latter up to 4.6 V.

Such a battery operates between about −40° C. and about +70° C. It can be recharged very quickly, to about 80% of its full capacity in less than 3 seconds. It does not have a risk of thermal runaway.

A third advantageous embodiment is a microbattery with:
a LiMn_{1.5}Ni_{0.5}O₄ cathode with a thickness comprised between approximately 1 μm and approximately 10 μm, with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or several of these oxides), a few nanometres thick over the entire mesoporous surface;
a Li₃PO₄ separator with a thickness comprised between approximately 1 μm and approximately 10 μm with a mesoporous porosity of approximately 35% and approximately 60%;
a Li₄Ti₅O₁₂ anode with a thickness comprised between approximately 1 μm and approximately 10 μm with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or more of these oxides), a few nanometres thick over the entire mesoporous surface.

The layer of an electronically conductive material coating is not necessary as long as the layers are not too thick, that is to say as long as at least the thickness of the electrodes remains less than approximately 5 μm or 6 μm.

The electrolyte can be an ionic liquid, for example EMIM-TFSI+LiFSI or Pyr₁₄TFSI+LiTFSI. Such a battery operates in a particularly wide temperature range, between about −40° C. and about +85° C. It can be recharged very quickly, to about 80% of its full capacity in less than 3 minutes. It does not have a risk of thermal runaway.

A fourth advantageous embodiment is a microbattery with:
a LiNi_{1/x}Co_{1/y}Mn_{1/z}O₂ cathode with x+y+z=10, with a thickness comprised between approximately 1 μm and approximately 10 μm, with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or more of these oxides), a few nanometres thick over the entire mesoporous surface;
a Li₃PO₄ separator with a thickness comprised between approximately 1 μm and approximately 10 μm with a mesoporous porosity of approximately 35% and approximately 60%;
a Li₄Ti₅O₁₂ anode with a thickness comprised between approximately 1 μm and approximately 10 μm with a mesoporous porosity of approximately 35% to approximately 60% including, preferably, on and inside its pores a layer of an electronically conductive material coating (carbon layer with metallic conductivity or layer of an electronically conductive oxide material coating, preferably selected from In₂O₃, SnO₂, ZnO, Ga₂O₃ and a mixture of one or more of these oxides), a few nanometres thick over the entire mesoporous surface.

The layer of an electronically conductive material coating is not necessary as long as the layers are not too thick, that is to say as long as at least the thickness of the electrodes remains less than approximately 5 μm or 6 μm.

The electrolyte can be an ionic liquid, for example EMIM-TFSI+LiFSI or Pyr₁₄TFSI+LiTFSI. Such a battery operates between about −20° C. and about +85° C. It has a high capacity. It does not have a risk of thermal runaway.

### EXAMPLES

### Example 1

Batteries were made with the following structure:
The cathode was made of LifePO₄, 7 μm thick, with a mesoporous porosity of about 50% and a metallic conductive carbon layer a few nanometres thick deposited over the entire mesoporous surface. The capacity of this cathode was about 145 mAh/g.
The separator was made of LisPO₄, about 6 μm thick, with a mesoporous porosity of about 50%.
The anode was made of Li₄Ti₅O₁₂, 8 μm thick, with a mesoporous porosity of about 50% and a deposition of a metallic conductivity carbon layer a few nanometres thick on the entire mesoporous surface. The capacity of this cathode was about 130 mAh/g.
The electrolyte was the ionic liquid of EMIM-TFSI+LiTFSI at 0.7 M, or the ionic liquid Pyr₁₄TFSI+LiTFSI always at 0.7 M.

Such a battery has the following features:
Volume capacity density: 70 mAh/cm³
Volume energy density: 120 mWh/cm³
Pulse power: 500 C
Continuous power: 50 C
Operating temperature range: from −40° C. to +125° C.
Fast charging: 80% charge in less than 3 minutes
Safety: No risk of thermal runaway

### Example 2

Microbatteries were made with the following structure:
The cathode was made of LiMn₂O₄, 8 μm thick, with a mesoporous porosity of about 50%, a metallic conductive carbon layer a few nanometres thick deposited over the entire mesoporous surface, and above this carbon layer a layer of alumina a few nanometres thick. The capacity of this cathode was about 130 mAh/g.
The separator was made of LisPO₄, about 6 μm thick, with a mesoporous porosity of about 50%.
The anode was made of Li₄Ti₅O₁₂, 8 μm thick, with a mesoporous porosity of about 50%, a metallic conductivity carbon layer a few nanometres thick over the entire mesoporous surface, and above this carbon layer a layer of alumina a few nanometres thick.
The capacity of this cathode was about 130 mAh/g.
The electrolyte was the ionic liquid Pyr₁₄TFSI+LiTFSI at 0.7 M.

Such a battery has the following features:
Volume capacity density: 60 mAh/cm³
Volume energy density: 150 mWh/cm³
Pulse power: 500 C
Continuous power: 50 C
Operating temperature range: from −40° C. to +70° C.
Fast charging: 80% charge in less than 3 minutes
Safety: No risk of thermal runaway

1. A lithium-ion battery comprising at least one stack,
the stack comprises successively: a first electronic current collector, a first porous electrode, a porous separator, a second porous electrode, and a second electronic current collector,
the battery comprises an electrolyte which is a liquid charged with lithium ions,
the electrolyte is confined in the porous layers,
wherein in said battery:
said first electrode is an anode and comprises a porous layer made of a material PA selected from the group formed by:
Nb₂₋ₓM¹ₓO_{5-δ}M³_{δ} wherein
M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M³ is at least one halogen,
and where 0≤x≤1 and 0≤δ≤2,
Nb₁₈₋ₓM¹ₓW_{16-y}M²_{y}O_{93-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen,
and where 0≤x≤1, 0≤y≤2 and 0≤δ≤2,
Nb₁₆₋ₓM¹ₓW_{5-y}M²_{y}O_{55-δ}M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen,
and where 0≤x≤1, 0≤y≤2 and 0≤δ≤2,
Nb₂O_{5-δ} with 0≤δ≤2, Nb₁₈W₁₆O_{93-δ} with 0≤δ≤2, Nb₁₆W₅O_{55-δ} with 0≤δ≤2, Li₄Ti₅O₁₂ and Li₄Ti₅₋ₓMₓO₁₂ with M=V, Zr, Hf, Nb, Ta and 0≤x≤0.25 and wherein a part of the oxygen atoms can be substituted by halogen atoms and/or which can be doped by halogen atoms, and said layer being free of binder, having a porosity comprised between 20% and 70% by volume,
said separator comprises a porous inorganic layer made of an electronically insulating inorganic material E, preferably selected from:
Al₂O₃, SiO₂, ZrO₂, and/or
a material selected from lithiated phosphates, optionally containing at least one element from: Al, Ca, B, Y, Sc, Ga, Zr; or from lithiated borates which may optionally contain at least one element from: Al, Ca, Y, Sc, Ga, Zr;
said material preferably being selected from the group formed by lithiated phosphates, preferably selected from: lithiated phosphates of the NaSICON type, Li₃PO₄; LiPO₃; Li₃Al_{0.4}Sc_{1.6}(PO₄)₃ called «LASP»; Li₁₊ₓZr₂₋ₓCaₓ(PO₄)₃ with 0≤x≤0.25; Li₁₊₂ₓZr₂₋ₓCaₓ(PO₄)₃ with 0≤x<0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤X≤1; Li₁₊ₓMₓ(Sc)₂₋ₓ(PO₄)₃ with M=Al, Y, Ga or a mixture of these three elements and 0≤x<0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li₁₊ₓAlₓTi₂₋ₓ(PO₄)₃ with 0≤x≤1 called «LATP»; or Li₁₊ₓAlₓGe₂₋ₓ(PO₄)₃ with 0≤x≤1 called «LAGP»; or Li₁₊ₓ₊₂Mₓ(Ge_{1-y}Ti_{y})₂₋ₓSi_{z}P_{3-z}O₁₂ with 0≤x≤0.8 and 0≤y≤1.0 and 0≤z≤0.6 and M=Al, Ga or Y or a mixture of two or three of these elements; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1+x+y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements;
said porous inorganic layer being free of binder, having a porosity comprised between 20% and 70% by volume;
said second electrode is a cathode and comprises a porous layer made of a material PC selected from the group formed by:
LiFePO₄,
phosphates of formula LiFeMPO₄ where M is selected from Mn, Ni, Co, V,
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and wherein 0<x<0.1, LiMn₂₋ₓMₓO₄ with M=Er, Dy, Gd, Tb, Yb, Al, Y, Ni, Co, Ti, Sn, As, Mg or a mixture of these compounds and wherein 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
oxides LiₓM_{y}O₂ where 0.6≤y≤0.85 and 0≤x+y≤2, and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where A and Me are each at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and wherein 0.6<x<1; 0<y<0.5; 0.25≤z<1; with A≠Me and A≠Nb, and 0≤p≤0.2;
LiₓNb_{y-a}NₐM_{z-b}P_{b}O_{2-c}F_{c} where 1.2<x≤1.75; 0≤y<0.55; 0.1<z<1; 0≤a<0.5; 0≤b<0.1; 0≤c<0.8; and where M, N, and P are each at least one of the elements selected from the group consisting of Ti, Ta, V, Cr, Mn, Fe, Co, Ni, Cu, Zn, Al, Zr, Y, Mo, Ru, Rh, and Sb;
oxides Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43} Ni_{0.27}O₂; Li_{1.3}Nb_{0.43}Co_{0.27}O₂; Li_{1.4}Nb_{0.2}Mn_{0.53}O₂;
oxides LiₓNi_{0.2}Mn_{0.6}O_{y} where 0.00≤x≤1.52; 1.07≤y<2.4; Li_{1.2}Ni_{0.2}Mn_{0.6}O₂;
compounds Li_{1.9}Mn_{0.95}O_{2.05}F_{0.95}, LiVPO₄F, FeF₃, FeF₂, CoF₂, CuF₂, NiF₂, Fe₁₋ₓMₓOF where 0<x<0.2 and M is at least one element selected from the group consisting of Co, Ni, Mn and Cu,
oxides LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z,
said porous layer being free of binder, having a porosity comprised between 20% and 70% by volume, said separator comprising a porous inorganic layer deposited on said first and/or second electrode, said porous inorganic layer being free of binder, having a porosity comprised between 20% and 70% by volume.

2. The battery according to claim 1, wherein at least one of the two porous layers includes, on and inside its pores, an electronically conductive material coating, said electronically conductive material preferably being carbon or an electronically conductive oxide material, and more preferably an electronically conductive oxide material selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of these four oxides,
doped oxides based on zinc oxide, the doping being preferably with gallium (Ga) and/or with aluminium (Al) and/or with boron (B) and/or with beryllium (Be), and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped oxides based on indium oxide, the doping being preferably with tin (Sn), and/or with gallium (Ga) and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped tin oxides, the doping being preferably with arsenic (As) and/or with fluorine (F) and/or with nitrogen (N) and/or with niobium (Nb) and/or with phosphorus (P) and/or with antimony (Sb) and/or with aluminium (Al) and/or with titanium (Ti), and/or with gallium (Ga) and/or with chromium (Cr) and/or with cerium (Ce) and/or with indium (In) and/or with cobalt (Co) and/or with nickel (Ni) and/or with copper (Cu) and/or with manganese (Mn) and/or with germanium (Ge).

3. The battery according to claim 2, wherein said electronically conductive material coating is coated with a layer which is electronically insulating and which has ionic conductivity, the thickness of said layer preferably being comprised between 1 nm and 20 nm.

4. The battery according to claim 1, wherein the pores of said first electrode have an average diameter of less than 50 nm.

5. The battery according to claim 1, wherein said stack including a first porous electrode layer, a porous separator and a second porous electrode layer, is impregnated with an electrolyte.

6. The battery according to claim 5, wherein said electrolyte is selected from the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer made ionically conductive by the addition of at least one lithium salt; and
a polymer made ionically conductive by the addition of a liquid electrolyte, either in the polymer phase or in the mesoporous structure.

7. The battery according to claim 1, wherein said material PA is Li₄Ti₅O₁₂ and/or in that said material PC is LiFePO₄ and/or in that said material E is Li₃PO₄.

8. The battery according to claim 1, wherein said material PA is Li₄Ti₅O₁₂, said material PC is LiMn₂O₄ and said material E is Li₃PO₄.

9. The battery according to claim 1, wherein said material PA is Li₄Ti₅O₁₂, said material PC is LiMn_{1.5}Ni_{0.5}O₄ and said material E is Li₃PO₄.

10. The battery according to claim 1, wherein said material PA is Li₄Ti₅O₁₂, said material PC is LiNi_{1/x}Co_{1/y}Mn_{1/2}O₂ with x+y+z=10, and said material E is Li₃PO₄.

11. A method for manufacturing a lithium-ion battery, according to claim 1, wherein:
said battery comprising comprises at least one stack;
the stack comprises successively: a first electronic current collector, a first porous electrode, a porous separator, a second porous electrode, and a second electronic current collector;
the battery comprises an electrolyte which is a liquid charged with lithium ions;
the electrolyte is confined in said porous layers;
said manufacturing method implementing a method for manufacturing an assembly including a first porous electrode and a porous separator;
said first electrode comprising a porous layer deposited on a substrate, said layer being free of binder, having a porosity comprised between 20% and 70% by volume, said separator comprising a porous inorganic layer deposited on said electrode, said porous inorganic layer being free of binder, having a porosity comprised between 20% and 70% by volume, wherein in said manufacturing method being characterised in that:
(a) a first porous electrode layer is deposited on said substrate,
(a1) said first electrode layer being deposited from a first colloidal suspension;
(a2) said layer obtained in step (a1) then being dried and consolidated, by pressing and/or heating, to obtain a first porous electrode; and, optionally,
(a3) said porous layer obtained in step (a2) then receiving, on and inside its pores, an electronically conductive material coating;
being understood that:
said first porous electrode layer may have been deposited on said first electronic current collector by carrying out the sequence of steps (a1) and (a2), and if necessary step (a3), or
said layer of a first electrode may have been previously deposited on an intermediate substrate in step (a1), dried and then detached from said intermediate substrate to be subjected to consolidation by pressing and/or heating to obtain a first porous electrode, then placed on said first electronic current collector, and said first porous electrode may have been subjected to step (a3);
(b) a porous inorganic layer of an inorganic material E which must be an electronic insulator is deposited on said first porous electrode deposited or placed in step (a),
(b1) said layer of a porous inorganic layer being deposited from a second colloidal suspension of particles of material E;
(b2) said layer obtained in step (b1) then being dried, preferably under a flow of air, and a heat treatment is carried out at a temperature below 600° C., preferably below 500° C., to obtain a porous inorganic layer, in order to obtain said assembly consisting of a porous electrode and a porous separator;
being understood that
the porous inorganic layer may have been deposited on said first electrode layer, by carrying out the sequence of steps (b1) and (b2), or the inorganic layer may have been previously deposited on an intermediate substrate in step (b1), dried and then detached from said intermediate substrate to be subjected, before or after being placed on said first electrode layer, to consolidation by pressing and/or heating to obtain a porous inorganic layer;
said first porous electrode layer and said porous inorganic layer are deposited by a technique selected from the group formed by: electrophoresis, extrusion, a printing method, preferably selected from ink-jet printing and flexographic printing, and a coating method, preferably selected from roll coating, curtain coating, doctor blade coating, extrusion slot die coating, dip-coating;
said first porous electrode layer and said porous inorganic layer are deposited from colloidal solutions including either
aggregates or agglomerates of monodisperse primary nanoparticles of at least one active material PA or PC of first electrode, or of at least one inorganic material E, respectively, with an average primary diameter D₅₀ comprised between 2 nm and 100 nm, said aggregates or agglomerates having an average diameter D₅₀ comprised between 50 nm and 300 nm, or
non-agglomerated or non-aggregated primary particles of at least one active material PA or PC of first electrode, or of at least one inorganic material E, respectively, with a primary diameter D₅₀ comprised between 200 nm and 10 μm,
knowing that:
if said first porous electrode is intended to be used in said battery as an anode, said material PA is selected from the group formed by:
Nb₂₋ₓM¹ₓO_{5-δ}M³_{δ} wherein
M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M³ is at least one halogen, preferably selected from F, Cl, Br, I or a mixture thereof
and wherein 0≤x≤1 and 0≤δ≤2,
Nb₁₈₋ₓM¹ₓW_{16-y}M²_{y}O_{93-δ} M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and wherein 0≤x≤1, 0≤y≤2 and 0≤δ≤2,
Nb₁₆ₓM¹ₓW_{5-y}M²_{y}O_{55-δ} M³_{δ} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Ge, Ce, Cs and Sn;
M¹ and M² can be identical or different from each other,
M³ is at least one halogen, preferably selected from F, Cl, Br, I or a mixture thereof,
and wherein 0≤x≤1, 0≤y≤2 and 0≤δ≤2,
Nb₂O_{5-δ} with 0≤δ≤2, Nb₁₈W₁₆O_{93-δ} with 0≤δ≤2, Nb₁₆W₅O_{55-δ} with 0≤δ≤2, Li₄Ti₅O₁₂ and Li₄Ti₅₋ₓMₓO₁₂ with M=V, Zr, Hf, Nb, Ta and 0≤x≤0.25 and wherein a part of the oxygen atoms can be substituted by halogen atoms and/or which can be doped by halogen atoms;
and if said first porous electrode is intended to be used in said battery as a cathode, said material PC is selected from the group formed by:
LiFePO₄,
phosphates of formula LiFeMPO₄ where M is selected from Mn, Ni, Co, V,
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and wherein 0<x<0.1, LiMn₂₋ₓMₓO₄ with M=Er, Dy, Gd, Tb, Yb, Al, Y, Ni, Co, Ti, Sn, As, Mg or a mixture of these compounds and wherein 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
oxides LiₓM_{y}O₂ where 0.6≤y<0.85 and 0≤x+y≤2, and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where A and Me are each at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and wherein 0.6<x<1; 0<y<0.5; 0.25≤z<1; with A≠Me and A≠Nb, and 0≤p≤0.2;
LiₓNb_{y-a}NₐM_{z-b}P_{b}O_{2-c}F_{c} where 1.2<x≤1.75; 0≤y<0.55; 0.1<z<1; 0≤a<0.5; 0≤b<0.1; 0≤c<0.8; and where M, N, and P are each at least one of the elements selected from the group consisting of Ti, Ta, V, Cr, Mn, Fe, Co, Ni, Cu, Zn, Al, Zr, Y, Mo, Ru, Rh, and Sb;
oxides Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43} Ni_{0.27}O₂; Li_{1.3}Nb_{0.43}Co_{0.27}O₂; Li_{1.4}Nb_{0.2}Mn_{0.53}O₂;
oxides LiₓNi_{0.2}Mn_{0.6}O_{y} where 0.00≤x≤1.52; 1.07≤y<2.4; Li_{1.2}Ni_{0.2}Mn_{0.6}O₂;
compounds Li_{1.9}Mn_{0.95}O_{2.05}F_{0.95}, LiVPO₄F, FeF₃, FeF₂, CoF₂, CuF₂, NiF₂, Fe₁₋ₓMₓOF where 0≤x<0.2 and M is at least one element selected from the group consisting of Co, Ni, Mn and Cu,
oxides LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z.

12. The method according to claim 11, wherein a second porous electrode layer is deposited on said porous inorganic layer, in a step (c), to obtain a stack comprising a first porous electrode layer, a porous inorganic layer and a second porous electrode layer,
(c1) said second porous electrode layer being deposited from a third colloidal suspension by a technique preferably selected from the group formed by: electrophoresis, extrusion, a printing method, preferably selected from ink-jet printing and flexographic printing, and a coating method, preferably selected from roll coating, curtain coating, doctor blade coating, extrusion slot die coating, dip-coating, said third colloidal suspension comprising either aggregates or agglomerates of monodisperse primary nanoparticles of at least one active material PA or PC of the second electrode, with an average primary diameter D₅₀ comprised between 2 nm and 100 nm, preferably between 2 nm and 60 nm, said aggregates or agglomerates having an average diameter D₅₀ comprised between 50 nm and 300 nm, that is to say non-agglomerated or non-aggregated primary particles of at least one active material PA or PC of the second electrode, with a primary diameter D₅₀ comprised between 200 nm and 10 μm; and
(c2) said layer obtained in step (c1) having then been consolidated, by pressing and/or heating, to obtain a porous layer; and, optionally,
(c3) said porous layer obtained in step (c2) then receiving, on and inside its pores, an electronically conductive material coating, so as to form said second porous electrode;
it being understood that said second porous electrode layer may have been deposited on said second electronic current collector by carrying out the sequence of steps (c1) and (c2), and where appropriate (c3), or said layer of a second electrode may have been deposited beforehand on an intermediate substrate by carrying out the sequence of steps (c1) and (c2), and if necessary (c3), and then has been detached from said intermediate substrate to be placed on said porous inorganic layer,
and it being understood that in the case where said first electrode layer has been made from a material PA, said second electrode layer is made with a material PC, and that in the case where said first electrode layer was made from a material PC, said second electrode layer is made with a material PA.

13. The method according to claim 11, wherein a second assembly consisting of a second porous electrode and a second layer of porous separator is deposited on a first assembly including a first porous electrode and a first layer of porous separator, so that said second separator layer is deposited or placed on said first separator layer, to obtain a stack comprising a first porous electrode layer, a porous inorganic layer and a second porous electrode layer.

14. The method according to claim 11, wherein the deposition of said electronically conductive material coating is carried out by the atomic layer deposition technique, or by immersion in a liquid phase including a precursor of said electronically conductive material, followed by the transformation of said precursor into an electronically conductive material.

15. The method according to claim 11, wherein said electronically conductive material is carbon or in that said electronically conductive material is selected from In₂O₃, SnO₂, ZnO, Ga₂O₃ and a mixture of one or several of these oxides.

16. The method according to claim 15, wherein said precursor is a carbon-rich compound, such as a carbohydrate, and in that said transformation into electronically conductive material is pyrolysis, preferably under an inert atmosphere.

17. The method according to claim 11, wherein a layer of an electronic insulator having ionic conductivity is deposited above said electronically conductive material coating.

18. The method according to claim 11, wherein said porous layer of a first electrode has a thickness comprised between 4 μm and 400 μm.

19. The method according to claim 11, wherein said porous inorganic layer has a thickness comprised between 3 μm and 20 μm, and preferably between 5 μm and 10 μm.

20. The method according to claim 11, wherein said porous layer of a first electrode has a specific surface comprised between 10 m²/g and 500 m²/g.

21. The method according to claim 11, wherein said inorganic material E comprises an electronically insulating material, preferably selected from:
Al₂O₃, SiO₂, ZrO₂, and/or
a material selected from lithiated phosphates, optionally containing at least one element from: Al, Ca, B, Y, Sc, Ga, Zr; or from lithiated borates which may optionally contain at least one element from: Al, Ca, Y, Sc, Ga, Zr;
said material preferably being selected from the group formed by lithiated phosphates, preferably selected from: lithiated phosphates of the NaSICON type, Li₃PO₄: LiPO₃; Li₃Al_{0.4}Sc_{1.6}(PO₄)₃ called «LASP»; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of these three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li₁₊ₓAlₓTi₂₋ₓ(PO₄)₃ with 0≤x≤1 called «LATP»; or Li₁₊ₓAlₓGe₂₋ₓ(PO₄)₃ with 0≤x≤1 called «LAGP»; or Li_{1+x+z}Mₓ(Ge_{1-y}Ti_{y})₂₋ₓSi_{z}P_{3-z}O₁₂ with 0≤x≤0.8 and 0≤y≤1.0 and 0≤z≤0.6 and M=Al, Ga or Y or a mixture of two or three of these elements; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1+x+y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x<0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements.

22. The method according to claim 11, wherein the cathode current collector is made of a material selected from the group formed by: Mo, W, Ti, Cr, Ni, Al, stainless steel, electronically conductive carbon and/or the anode current collector is made of a material selected from the group formed by: Cu, Mo, W; Ta, Ti, Cr, stainless steel, electronically conductive carbon.

23. The method according to claim 11, wherein said stack including a first porous electrode layer, a porous separator and a second porous electrode layer is impregnated with an electrolyte, preferably a lithium-ion carrier phase, selected from the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer made ionically conductive by the addition of at least one lithium salt; and
a polymer made ionically conductive by the addition of a liquid electrolyte, either in the polymer phase or in the mesoporous structure,
said polymer preferably being selected from the group formed by poly(ethylene oxide), poly(propylene oxide), polydimethylsiloxane, polyacrylonitrile, poly(methyl methacrylate), poly(vinyl chloride), poly(vinylidene fluoride), PVDF-hexafluoropropylene.

24. A method implementing the battery according to claim 1, wherein the battery is used at a temperature below −10° C. and/or at a temperature above +80° C.

25. The battery according to claim 1, the pores of said inorganic layer have an average diameter of less than 50 nm.

26. The battery according to claim 1, wherein the pores of said second electrode have an average diameter of less than 50 nm.

27. The battery according to claim 3, wherein the thickness of the layer is comprised between 1 nm and 20 nm.
